(19) United States
(12) Patent Application Publication
(10) Pub. No.: US 2024/0373974 A1
(43) Pub. Date: Nov. 14, 2024

(54) ADAPTER DEVICE FOR A CLICK ELEMENT

(71) Applicants: Jannik REKER, Köln (DE); Verónica RODRÍGUEZ VILLARREAL, Köln (DE)

(72) Inventors: Jannik REKER, Köln (DE); Verónica RODRÍGUEZ VILLARREAL, Köln (DE)

(21) Appl. No.: 18/564,298

(22) PCT Filed: May 24, 2022
(86) PCT No.: PCT/EP2022/063960

§ 371 Date: Nov. 27, 2023

(30) Foreign Application Priority Data
May 28, 2021 (DE) DE 202021102913.7

(51) Int. Cl. A43B 5/18; B62M 3/08

(52) U.S. Cl. CPC A43B 5/18; B62M 3/086

(57) ABSTRACT

The invention relates to an adapter device (100), comprising an adapter unit (102) which has at least one mounting section (106) which is designed and intended to mount at least one click element (108), not belonging to the adapter device, of a clipless pedal system, likewise not belonging to the adapter device, on the adapter unit (102) in an operationally fixed manner, and a fastening unit (104) which is designed and intended to fasten the adapter unit (102) releasably to an everyday shoe (110), likewise not belonging to the adapter device.

The present invention relates to an adapter device for a click element of a clipless pedal, in particular a bicycle clipless pedal.

For effective power transmission, clipless pedal systems are often used on bicycles. A conventional clipless pedal system comprises specially shaped clipless pedals that interact with a cleat. The cleat is detachably attached to a special bicycle shoe. Before or during the ride, the cleat is used to lock the cycling shoe into a pedal plate of the clipless pedal.

The special cycling shoes are equipped with a very stiff and hard sole to ensure that the cleat can be fitted securely. As a result, walking with cycling shoes is very uncomfortable and unstable. It is therefore difficult and impractical to walk long distances in cycling shoes. This effect is further exacerbated by the hard cleat. As a result, cycling shoes are not suitable for everyday use and clipless pedal systems are mainly used in professional and amateur sports, but not for everyday rides, for example in the city and bike packing tours or spinning classes. Cycling shoes are therefore only worn for cycling, so it is always necessary to also carry everyday shoes.

The purpose of the present invention is to provide a solution to this problem.

According to a first aspect of the present invention, this task is solved by an adapter device, comprising an adapter unit which has at least one mounting section which is designed and intended to mount at least one click element, not belonging to the adapter device, of a clipless pedal system, likewise not belonging to the adapter device, on the adapter unit in an operationally fixed manner, and a fastening unit which is designed and intended to fasten the adapter unit releasably to an everyday shoe, likewise not belonging to the adapter device.

The adapter device according to the invention makes it possible to use clipless pedals even when wearing everyday shoes. It is no longer necessary to change shoes between cycling shoes, which are adapted to the clipless pedal system, and everyday shoes, which enable comfortable and safe everyday walking, as only the adapter device needs to be removed from the everyday shoe. While riding, the click element mounted securely on the adapter device engages with a clipless pedal of the clipless pedal system that is not part of the adapter device. As a result, the force is transmitted between the foot and the clipless pedal via an optimum pressure point. The present invention thus combines the advantages of a conventional clipless pedal system with the advantages of wearing conventional everyday shoes.

While conventional cycling shoes only allow a small amount of leeway with regard to the positioning of the click element in relation to the foot, the adapter device according to the invention also offers greater variability and therefore an ergonomic improvement. A positive connection is created between the everyday shoe and the click element, which leads to an improvement in the transmission of force to the clipless pedal. The adapter device and the everyday shoe are non-positively connected. The adapter device according to the invention not only allows a compressive force to be exerted during the downward movement of the pedal, but also a tensile force during the upward movement. The result is an improved pedaling sequence with more efficient power transmission and a high level of comfort for the everyday shoe. Twisting or injuries caused by the connection between the foot and clipless pedal being released too late or not at all are avoided by using existing, tried and tested clipless pedal systems consisting of a clipless element and clipless pedal.

The adapter device can be easily attached to and detached from an everyday shoe without the need for a tool. When in use, the adapter device is detachably attached to the everyday shoe. When the bicycle is being ridden, the click element mounted on the adapter device engages with the clipless pedal. It is not necessary to assign the adapter device to a specific everyday shoe. The everyday shoe to which the adapter device is detachably attached can be selected as required for each use. The invention thus combines the functionality and safety of a conventional cycling shoe with the comfort of an everyday shoe.

It should be noted here that a detachable fastening in the context of the present invention is understood to mean a fastening that is set up for rapid and regularly putting on and taking off, i.e. the regular and rapid making and releasing of the connection. Means by which a detachable fastening can be achieved are, for example, straps, belts and/or quick-release fasteners.

In contrast, in the context of the present invention, a fixed assembly is understood to be an assembly that is designed to remain in place for the long term. Although it is possible in principle to detach the components, which are mounted to each other in an operationally fixed manner, this is only intended for replacing at least one component, for example due to wear or a defect. Screws and/or rivets and/or clamps, for example, can be used for secure mounting.

Advantageously, the fastening unit comprises at least one fastening element. The at least one fastening element can be connected to the adapter unit. For example, the fastening unit can comprise four fastening elements. In the case of more than one fastening element, the fastening elements can be arranged parallel to one another or overlapping one another, preferably crosswise overlapping, in a fastening state. The fastening state is understood to be the state in which the adapter device is attached to the everyday shoe.

To make it easier to position the adapter unit on the sole of the everyday shoe, the adapter unit can have at least one fastening eyelet for connecting the at least one fastening element to the adapter unit. The at least one fastening eyelet can preferably protrude from the adapter unit, for example on a corner section of the adapter unit, for example on the top of the adapter unit. Preferably, the adapter unit has fastening eyelets on all four corners of the adapter unit. In this way, the adapter device according to the invention can achieve additional protection against unplanned detachment of the adapter device from the everyday shoe. The adapter device can thus be more easily adapted to different everyday shoes.

In a further development of the invention, the adapter unit can comprise an upper adapter sub-unit and a lower adapter sub-unit, which can lie directly or indirectly against each other in the height direction, at least when the adapter device is in use.

Furthermore, at least one fastening element can be sandwiched between the upper adapter sub-unit and the lower adapter sub-unit, preferably clamped between the upper adapter sub-unit and the lower adapter sub-unit. At least one continuous fastening element can be sandwiched between the two adapter subunits, for example. This has the advantage that the two sections of the fastening element protruding laterally from the adapter subunits support each other, so that the holding force does not have to be applied from the adapter unit. In principle, however, it is also conceivable that a free end of two fastening elements can be sandwiched between the two adapter subunits. It is also conceivable that the two free ends of the fastening elements are connected to each other, preferably with a material bond, for example by sewing, gluing, welding and the like.

Irrespective of the exact type of operationally fixed mounting of the at least one fastening element on the adapter unit, it is advantageous if at least two fastening element sections, which can be arranged on different edge sections of the adapter unit, lie opposite each other in the transverse direction.

At this point, it should be noted that the terms “transverse direction” and “longitudinal direction” in the context of the present invention refer to a state of the adapter unit in which it is attached to an everyday shoe. The longitudinal direction corresponds to the longitudinal direction of the everyday shoe from its toe area to its heel area, while the transverse direction corresponds to the transverse direction of the everyday shoe between its inner side and its outer side. Furthermore, the “height direction” is orthogonal to both the longitudinal direction and the transverse direction.

According to the latter further development of the invention, a symmetrical force distribution is achieved. In addition, the adapter device can be positioned in the transverse direction approximately in the middle of the everyday shoe. An ergonomically optimized positioning of the adapter device that deviates from the middle is also conceivable. In this way, the positioning of the adapter device and thus the optimum pressure point can be adapted to the individual foot shape. The two fastening element end sections can be fastening element end sections of one fastening element or fastening element end sections of different fastening elements.

For additional stabilization, two fastening element sections can be attached to a rear end of the adapter unit, preferably to two corner sections of the rear end of the adapter unit that are opposite each other in the transverse direction. This allows at least one fastening element to be detachably attached to a heel or a leg of a wearer of the adapter device. A relative movement in the longitudinal direction of the adapter device to an everyday shoe is reduced. It should be noted that the rear end corresponds to the heel end.

In a further development of the invention, the adapter unit can have an asymmetric contour when viewed from above. Asymmetry in the longitudinal direction facilitates correct assignment to the heel or toe side, while asymmetry in the transverse direction facilitates differentiation between the inner and outer side. For example, an adaptation to the shape of a foot to differentiate between left and right is possible by a non-straight, e.g. curved course of an outer side. This enables correct positioning of the adapter device on an everyday shoe. Consequently, accidents and/or injuries due to an incorrectly positioned adapter device are reduced and safety is increased.

In order to save material and thus reduce manufacturing costs, the adapter unit can be plate-shaped. This can also achieve a more direct transmission of force. It is also conceivable to adapt the adapter unit to a shape determined by topology optimization, which includes, for example, recesses and optimized contours, which can further reduce the weight.

In order to protect the click element and to be able to guide it on the pedal when clicking in, the adapter unit can comprise at least one side wall that protrudes from a base plate of the adapter unit on the side that is intended for mounting the click element. For this purpose, the side wall can, for example, be arranged in such a way that it surrounds the click element on all sides when it is securely mounted on the adapter unit. Furthermore, the inner boundary surfaces of the side wall can be beveled, at least in sections, in order to facilitate guidance on the pedal and thus the engagement of the click element with the clipless pedal. In use, i.e. when the adapter device is attached to an everyday shoe and is engaged with a clipless pedal system, the at least one side wall points downwards.

For further protection of the click element, the at least one side wall can be arranged in such a way that it has a predetermined minimum distance from the click element when it is mounted. This minimum distance can be approximately 10 mm, for example. The at least one side wall designed in this way protects the click element from external influences such as hits or the like, without impairing the click function, in particular clicking in and out. The click element can be unclicked by turning the click element or the adapter device by approximately 30° to 45° in the transverse direction.

Since commercially available click elements have a height of around 3 mm to 7 mm, it is advantageous if the at least one side wall has a height of at least 6 mm, preferably at least 8 mm. While running with the adapter device attached, the rolling movement takes place over the surface of the at least one side wall facing away from the base plate. Contact between the click element and the ground is thus avoided and the at least one side wall also protects the click element while running with the adapter device attached and also increases comfort when running by rolling over the side wall.

In order to increase safety, for example against slipping, while walking with the adapter device attached to an everyday shoe, a surface of the at least one side wall facing away from the base plate can be provided with a profile and/or manufactured using an elastic, non-slip material. Advantageously, the surface of the at least one side wall facing away from the base plate can be coated with an elastic, non-slip material. Elastomers such as thermoplastic polyurethane (TPU) and/or acrylonitrile-butadiene-styrene copolymer (ABS) and/or nylamide can be used as an elastic, non-slip material.

For improved force transmission, the adapter unit can be manufactured using a rigid material, preferably metal, for example using steel and/or aluminum, and/or using a plastic, for example a high-strength plastic, in particular a fiber composite material. The use of a rigid material reduces elastic deformation and force losses during the transmission of force to the clipless pedal. A rigid material in the sense of the present invention is characterized by a modulus of elasticity of more than 2,000 MPa, preferably of about 2,500 MPa. For example, fiber composite material with carbon fibers or acrylonitrile-butadiene-styrene copolymers can be used.

In order to reduce or prevent relative movement, i.e. slippage, of the everyday shoe in relation to the adapter unit, the adapter unit can be provided with at least one hole that is designed and intended to accommodate a pedal pin. For example, six such holes may be provided. The at least one hole is provided at least on the side of the adapter unit facing away from the side of the adapter unit that is intended for mounting the click element. A through-hole is also conceivable. In the case of more than one hole, these holes can preferably be distributed around the mounting point.

Stability during walking and ergonomics can be improved by manufacturing the adapter unit using a non-slip material and/or shock-absorbing material. Advantageously, the adapter unit can be coated with a non-slip material and/or a shock-absorbing material. For example, an elastomer, in particular thermoplastic polyurethane (TPU) and/or acrylonitrile-butadiene-styrene copolymer (ABS) and/or nylamide, can be used as a non-slip and/or shock-absorbing material.

When the pedals are pressed, a tilting moment around the transverse axis can occur. In order to support this tilting moment, the adapter unit can have a predetermined minimum length in the longitudinal direction. This further improves load distribution and power transmission. In addition, such an adapter unit offers a larger surface area, for example for attaching a number of fastening elements. hen pedalling the clipless pedals lower pressure and greater comfort can also be achieved. It is also conceivable to design the adapter device in different sizes so that it is adapted to soles of different sizes, for example to shoe sizes from 36 to 47 EU.

In a further embodiment of the invention, the adapter unit can comprise a front adapter sub-unit and a rear adapter sub-unit. The front adapter sub-unit and the rear adapter sub-unit can be arranged in the longitudinal direction such that the front adapter sub-unit is arranged on the toe side and the rear adapter sub-unit is arranged on the heel side. This leads to an increase in the contact surface of the adapter unit and improve force transmission. Advantageously, the fastening unit and/or at least one fastening element can be attached to the front adapter sub-unit. It is also conceivable that at least one additional fastening element is fastened to the rear adapter sub-unit, which further improves the load distribution and the hold of the adapter device on the everyday shoe. The front adapter sub-unit and the rear adapter sub-unit can be connected to each other via a screw connection, for example.

The optimum pressure point depends on the rider's anatomy. For an optimized positioning of the adapter device, the front adapter sub-unit can be designed and intended so that at least one click element not belonging to the adapter device is permanently mounted on the front adapter sub-unit. This ensures that the optimum pressure point is positioned under the center of the foot when the click system engages.

Advantageously, the front adapter device can be designed in accordance with at least one of the features of the adapter unit described above. In particular, it is conceivable in principle to divide the front adapter sub-unit and/or the rear adapter sub-unit in the height direction, so that they comprise an upper adapter sub-unit and a lower adapter sub-unit. At least one fastening element can also be attached to the rear adapter subunit.

It should be noted at this point that all features, advantages and functions described in relation to the adapter unit according to the present invention may also be applicable to the front adapter sub-unit and vice versa.

It is advantageous for transportation if the adapter device is easy to stow away. This can be achieved by the front adapter sub-unit and the rear adapter sub-unit being movably connected to each other, for example by means of a joint. Advantageously, the joint can be folded through at least 180° so that the rear adapter sub-unit and the front adapter sub-unit lie on top of each other in a folded state and the adapter device can be transported in a space-saving manner, for example in a trouser pocket. Due to the movable connection between the front and rear adapter sub-unit, the movement of the adapter device adapts ergonomically 9 to the rolling and bending movement of the foot. Furthermore, this can improve the separation of the front and rear adapter sub-units, which is particularly advantageous when replacing one of the front or rear adapter sub-units. For example, replacing the front adapter sub-unit with another front adapter sub-unit to which a click element of another clipless pedal system is permanently attached is quicker than removing and then fitting different click elements to the same front adapter sub-unit.

A reduction in material and thus a reduction in weight and manufacturing costs can be achieved by the rear adapter sub-unit comprising at least one recess. The at least one recess can comprise a material recess or be continuous. Various shapes are conceivable for the at least one recess. By way of example, but not exhaustively, a round shape, an elongated shape, a polygonal shape, a rectangular shape and a shape with rounded edges are mentioned here.

In a further development of the invention, the assembly section can comprise an insert unit which is designed and intended to accommodate different insert units. Different insert units can be adapted to different pedal systems, so that a quick adaptation to different clipless pedal systems is possible by changing the insert unit. Furthermore, an insert element can be designed and intended to be mounted on one side of a pedal, for example a platform pedal without click function, in an operationally fixed manner and to be connectable to the adapter unit via the click element on the opposite side in a height direction. In this way, the described advantages of the adapter device according to the invention can also be realized in conjunction with a pedal without a click function.

For easy handling and fastening of the adapter device, the at least one fastening element can comprise at least one strap and/or at least one belt and/or at least one cord. This results in a low weight. Furthermore, this type of fastening element can be stored or transported in a space-saving manner, for example by rolling up the at least one strap and/or the at least one belt and/or the at least one cord. Preferably, a strap and/or a belt and/or a cord may be arranged such that it/they rests approximately against the ball of the foot in the fastening state, and a second strap and/or a second belt and/or a second cord may be arranged such that it/they rests approximately against the navicular bone in the fastening state. The fastening therefore takes place at the force-transmitting points and slipping of the everyday shoe out of the adapter device can be prevented.

The stability of the fastening element can be increased by using several straps and/or belts and/or cords. The safety against material failure can also be improved. The at least one strap and/or the at least one belt and/or the at least one cord can have a width of between approximately 10 mm and approximately 60 mm, preferably between approximately 25 mm and approximately 50 mm.

In order to be able to hold the adapter device in position and prevent relative movement between the everyday shoe and the adapter device, it is advantageous if the at least one strap and/or the at least one belt and/or the at least one cord is manufactured using a material with a high tensile stiffness, for example using a textile, most preferably a woven polyester material, and/or using an elastic material. These materials have the advantage that they can flexibly adapt to differently shaped everyday shoes and at the same time prevent the everyday shoe from slipping due to stretching of the material. Furthermore, this type of material is resistant to tearing. For example, the material of conventional instep straps can be used.

Preferably, the at least one strap and/or the at least one belt and/or the at least one cord can have non-slip or at least slip-resistant material on at least one side, preferably on the side that is assigned to the everyday shoe in the fastened state. For example, the at least one side can be provided with barbs. Furthermore, the adapter device can clamp the everyday shoe via a plurality of elastic straps and/or belts and/or cords.

For quick and easy attachment and detachment of the adapter device to or from the everyday shoe, the at least one fastening element can comprise a quick-release fastener. As a result, the at least one fastening element can be tensioned in such a way that relative movement of the everyday shoe and adapter device is reduced or avoided. The quick-release fastener can be selected from the group of quick-release fastener elements formed by lashing eyelets, drawstring fasteners, tension fasteners, twist fasteners, push-turn fasteners, Velcro fasteners, Velcro fasteners with lashing function, buckles, clamping buckles, plug-in fasteners, ratchets and zippers. Preferably, the quick-release fastener can be provided on the side of the adapter unit facing away from the click element. Furthermore, the quick-release fastener can be provided with a pad on the side facing the everyday shoe in the fastening state. This can cushion the pressure that the quick-release fastener exerts on the foot bone.

For flexible adaptation of the adapter device to different click elements and click systems, the mounting section can have a plurality of holes, preferably two or three holes. In the case of two holes, the holes are preferably arranged parallel to each other. In the case of three holes, these can be arranged at the corners of an isosceles triangle. The majority of holes can be designed as blind holes. An equally conceivable design as through holes leads to simplified production. The provision of four holes is also conceivable.

For improved force transmission, the click elements can be adapted to different anatomies by allowing them to assume different mounting positions. It is therefore advantageous if the majority of holes are designed as slotted holes.

Preferably, the elongated holes extend essentially in the longitudinal direction. This enables improved positioning of the click element and thus indirectly the setting of the optimum pressure point. Preferably, the elongated holes have a width of more than 5 mm, most preferably approximately 7 mm and/or a length of less than 28 mm, most preferably approximately 15 mm.

Positioning is further simplified if at least one hole has an internal thread. For example, each hole can have an internal thread. The internal thread can be an internal thread insert, for example. It is also advantageous if the internal thread is slidably arranged within an elongated hole.

The adapter unit can be provided with at least one scale next to at least one of the plurality of holes. This enables better and easier positioning and alignment of the click element. Preferably, a zero point of the scale can be arranged at the heel-side end of a hole.

According to a second aspect, the present invention relates to a combination of an adapter device according to the first aspect of the invention with a click element which is mounted on the adapter device in an operationally fixed manner.

It should be noted at this point that all features, advantages and functions that have been and will be described in relation to the adapter device according to the present invention may also be applicable to the combination according to the invention and vice versa.

The combination may further comprise an everyday shoe to which the adapter device can be detachably attached. Preferably, the adapter device is selected such that at least 10%, preferably at least 15%, further preferably at least 20%, further preferably at least 25%, and further preferably at least 30%, of the sole of the everyday shoe is covered by the adapter unit.

For the sake of completeness, it should be noted that the adapter device is suitable for clipless pedal systems, preferably for a bicycle. It goes without saying that this includes, but is not limited to, a trekking bike, a racing bike, a mountain bike, but also a pedelec or a stationary bike, e.g. for fitness training.

The Invention Will be Explained in More Detail Below with Reference to the Attached Drawing Using Examples of Embodiments. It Depicts:

FIG. 1a perspective view of a combination of an adapter device according to the invention with an everyday shoe and a click element;

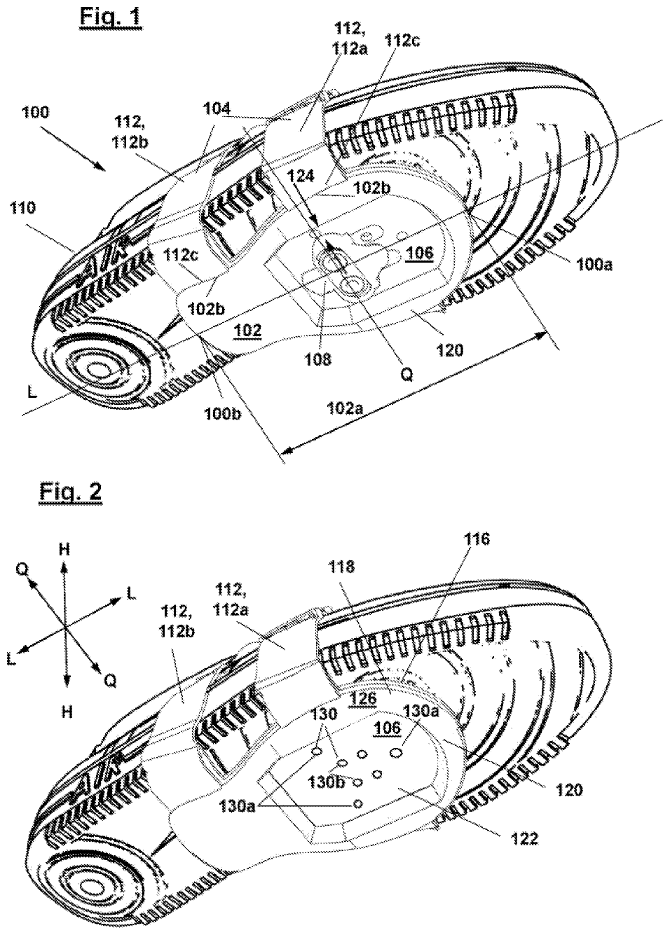

FIG. 2 is a view similar to FIG. 1, but without the click element;

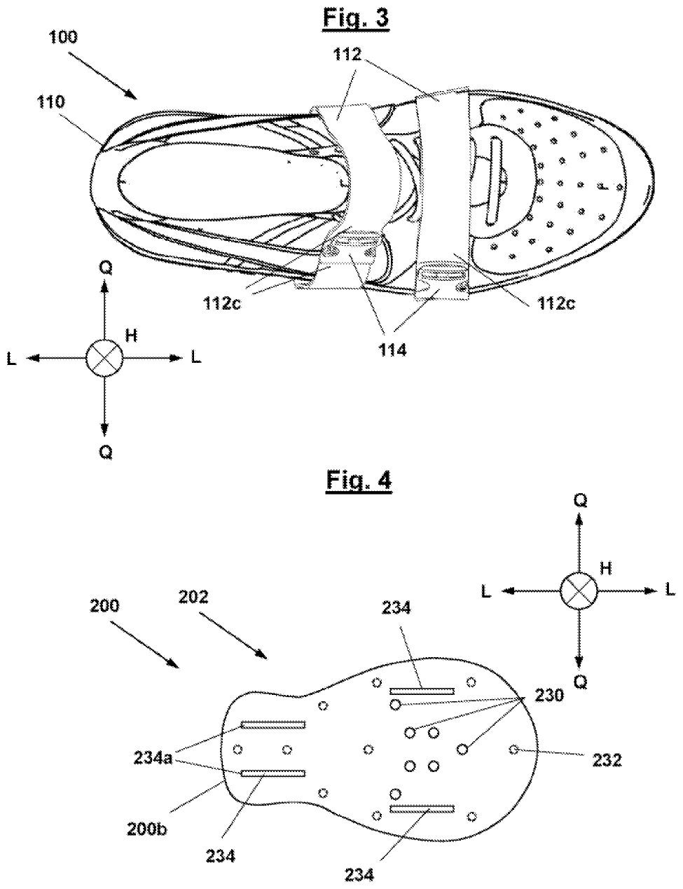

FIG. 3 is a top view of the combination shown in FIG. 1;

FIG. 4 Top view of a second embodiment of an adapter unit;

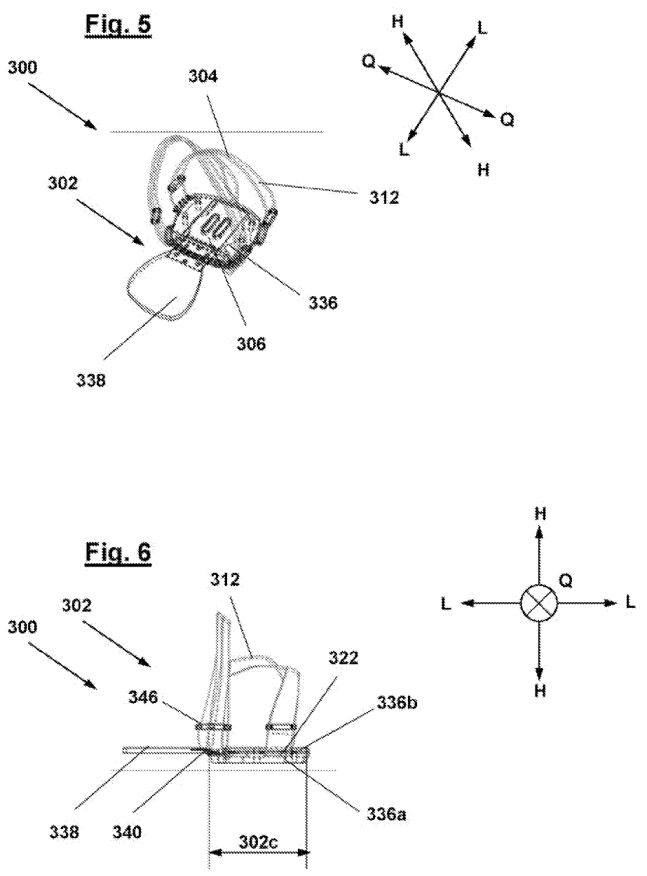

FIG. 5a perspective view of the adapter device of a third embodiment;

FIG. 6 is a side view of the adapter device from FIG. 5;

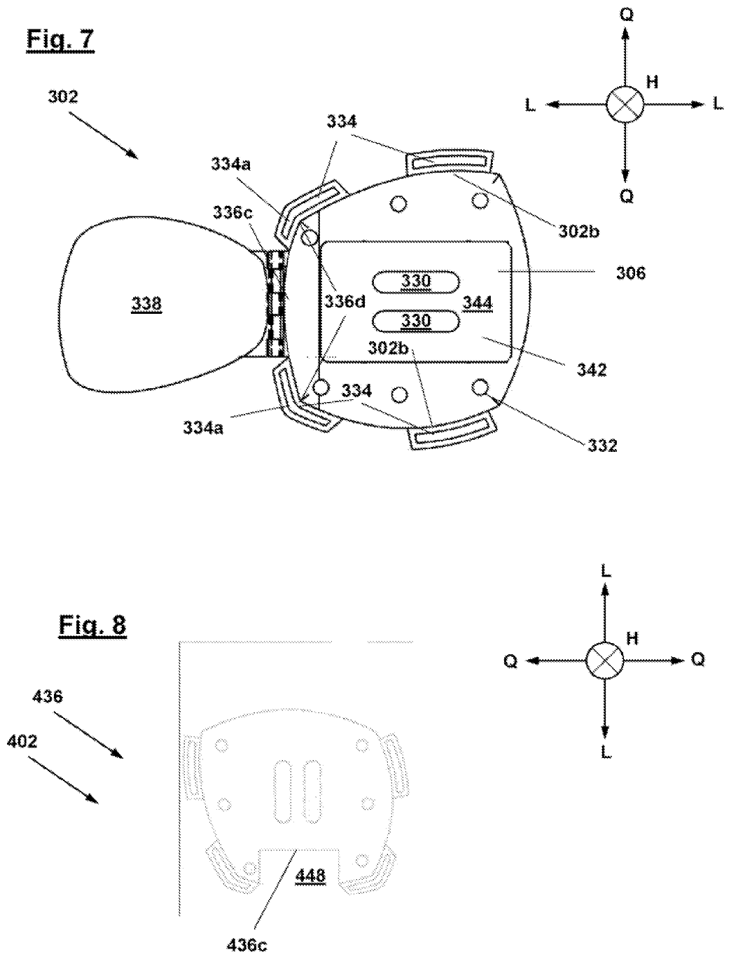

FIG. 7 is a top view of the adapter unit from FIG. 5;

FIG. 8 a top view of an adapter unit of a fourth embodiment;

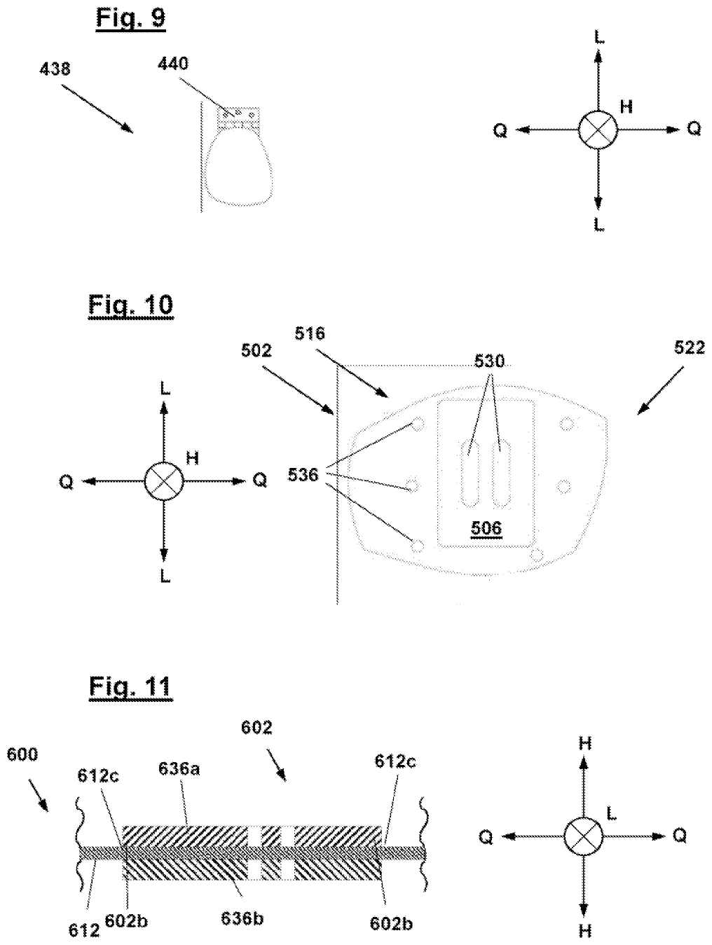

FIG. 9: Top view of a rear adapter sub-unit;

FIG. 10 a top view of an upper adapter subassembly; and

FIG. 11 a cross-section of an adapter unit viewed in the longitudinal direction.

In FIG. 1, an adapter device according to the invention is generally designated 100. The adapter device 100 comprises an adapter unit 102 and a fastening unit 104.

The adapter device 100 extends in a longitudinal direction L between a front end 100a, the toe side end in the usual fastening state, and a rear end 100b, the heel side end in the usual fastening state. A transverse direction Q extends orthogonally to the longitudinal direction L, which in a fastening state extends between an inner side and an outer side of the everyday shoe. A height direction H extends orthogonally to both the longitudinal direction L and the transverse direction Q.

A click element 108 is operationally fixedly mounted on the adapter unit 102 in a mounting section 106. The click element 108 is designed to engage in a clipless pedal of a clipless pedal system belonging to the click element 108.

The adapter device 100 is detachably attached to an everyday shoe 110. In other words, the adapter device 100 is shown in FIG. 1 in a fastening state. In this fastening state, the adapter unit 102 rests against the sole of the everyday shoe 110 in such a way that the mounting section 106 and with it the click element 108 are positioned under the center of the foot. In order to be able to avoid permanent loading and/or overloading, a positioning of an adapter device 100 according to the invention on an everyday shoe is advantageous, in which the mounting section is arranged in the transverse direction in a middle position between the big toe joint and the small toe joint and in the longitudinal direction approximately on an axis with the big toe base joint.

For improved load distribution and force transmission, the adapter unit 102 has a predetermined minimum length 102a in the longitudinal direction L. For example, the predetermined minimum length 102a can be approximately 13 cm. The predetermined minimum length 102a can be at least 20%, preferably approximately 50%, of the length of the everyday shoe 110.

The adapter unit 102 is plate-shaped and has an asymmetrical contour, in this case in the longitudinal direction L. For example, the adapter unit 102 can have a pear-shaped contour. The adapter unit 102 can be formed in the direction of a front end of the adapter unit 102 similar to a section of an ellipse. In the direction of a rear end of the adapter unit 102, the adapter unit tapers and changes into a cuboid-like contour with rounded corners.

Two fastening elements 112 are arranged on the adapter unit 102 in the illustrated embodiment example. The adapter device 100 can be detachably fastened to the everyday shoe 110 by means of the fastening elements 112. The fastening elements 112 can, for example, be formed by straps. Other designs, including straps or cords, are also conceivable.

A front fastening element 112a is arranged in front of a rear fastening element 112b in the longitudinal direction. The rear fastening element 112b is located at the rear end of the adapter unit 102. Each of the two fastening elements 112a, 112b is arranged at two fastening element portions 112c on an edge portion 102b of the adapter sub-unit. The two fastening element sections 112c, which are to be assigned to the same fastening element 112, i.e. either the front fastening element 112a or the rear fastening element 112b, are arranged at edge sections 102b of the adapter unit 102 that are different from one another, the edge sections 102b being opposite one another in the transverse direction Q. The fastening element 112 is placed around the everyday shoe 110 in the fastened state, so that a positive fit is created with the everyday shoe 110. Two end sections 112c can be connected to each other by a quick-release fastener 114 (see FIG. 3).

In the fastening state, the front fastening element 112a can be arranged at the level of the forefoot and the rear fastening element 112b at the level of the midfoot. Furthermore, it is possible to attach a third fastening element 112 to the adapter unit 102 in such a way that it can be attached to the everyday shoe above the heel.

The adapter unit 102 has an upper adapter sub-unit 116 and a lower adapter sub-unit 118. The upper adapter sub-unit 116 and the lower adapter sub-unit 118 rest against each other when the adapter device is in use. The upper adapter sub-unit 116 is arranged above the lower adapter sub-unit 118 in the height direction H.

The fastening element 112 is sandwiched or clamped between the upper adapter subunit 116 and the lower adapter subunit 118. The upper adapter sub-unit 116 and the lower adapter sub-unit 118 are therefore in direct or at least indirect contact with one another via the at least one fastening element 112.

It should be noted at this point that a relative movement in the transverse direction Q between the fastening element 112 and the adapter unit 102 is prevented by the fact that the fastening element 112 is clamped between the upper adapter sub-unit 116 and the lower adapter sub-unit 118. In order to position the fastening element 112 in a position adapted to the everyday shoe, the fastening element 112 can be sandwiched between the upper 116 and the lower adapter sub-unit 118.

At the mounting section 106, the adapter unit 102 has a side wall 120. The side wall 120 can be formed in one piece with a base plate 122 and have a circumferential shape. The side wall 120 protrudes from the base plate 122 on a lower side of the adapter unit 102, namely on that side of the base plate 122 which is intended for mounting the click element 108. The click element 108 and the side wall 120 are arranged at a distance 124 from one another, wherein the distance 126 is not less than a predetermined minimum distance.

The side wall 120 may have a height of at least 6 mm, preferably at least 8 mm. In this way, contact between the click element 108 and the ground can be avoided while walking with the adapter device 100 attached to the everyday shoe 110. In order to increase safety, for example against slipping while walking with the adapter device 100 attached to the everyday shoe 110, a surface 126 of the at least one side wall 120 facing away from the base plate 122 can be provided with a profile and/or manufactured using an elastic, non-slip material.

As shown in FIG. 2, the mounting section 106 has a plurality of holes 130. A click element can be operationally fixed to the adapter unit 102 via the plurality of holes 130.

At least one hole 130 is provided with an internal thread, through which the click element 108 can be mounted on the adapter unit 102. It is also possible to provide a scale (not shown) next to at least one of the holes 130.

Three holes 130a form the corners of an isosceles triangle. A click element of a conventional racing bike clipless pedal system can be securely mounted to these holes 130a.

Additionally or alternatively, at least one pair of holes 130b can be provided on the mounting section 106, which are arranged next to each other in the transverse direction Q. By means of these holes 130b, a click element of a conventional mountain bike clipless pedal system can be mounted in an operationally fixed manner. The provision of a plurality of pairs of holes 130b, for example two in FIG. 2, makes it possible to position the click element so that it is arranged at the individual pressure point of an everyday shoe.

FIG. 4 shows a top view of an adapter unit 202 of an adapter device 200, which essentially corresponds to the adapter unit 102 as shown in FIGS. 1 to 3. In FIG. 4, therefore, analogous parts are provided with the same reference signs as in FIGS. 1 to 3, but increased by 100. Furthermore, the adapter unit 202 is described below only insofar as it differs from the adapter unit 102 as shown in FIGS. 1 to 3, to the description of which express reference is hereby made.

The adapter unit 202 also comprises a plurality of holes 230, which are provided and set up for the operationally fixed mounting of a click element. Here to, at least one of the holes 230 can have an internal thread, for example an internal thread of the M5 type.

The adapter unit 202 is provided with a plurality of holes 232 (shown dashed), which are distributed over the entire surface of the adapter unit. A pedal pin (not shown) can be inserted into each of the holes 232. For the use of commercially available pedal pins, the holes 232 can be provided with an internal thread, for example of the M4 type.

Fastening eyes 234 are provided on the adapter unit 202, two of which are opposite each other in the transverse direction Q. In particular, two fastening eyelets 234a are formed at a rear end 200b. The fastening eyes 234 can be shaped as elongated slots, for example with a length of approximately 26 mm.

Two fastening element sections of at least one fastening element can be guided through two fastening eyes 234 opposite each other in the transverse direction. For detachable fastening of the adapter device 200 to an everyday shoe, two ends of the fastening element 212 can be connected to one another on a side of the everyday shoe opposite the adapter unit 202, for example by means of a quick-release fastener or by lacing two fastening end sections together.

A further embodiment of an adapter device 300 according to the invention is shown in FIGS. 5 to 7. The adapter device 300 essentially corresponds to the adapter device 100 according to FIGS. 1 to 3 and the adapter device 200 according to FIG. 4. Therefore, in FIGS. 5 to 7, analogous parts are provided with the same reference signs as in FIGS. 1 to 3 or in FIG. 4, but increased by 200 or 100. Furthermore, the adapter device 300 is only described to the extent that it differs from the adapter devices 100 and 200 of FIGS. 1 to 4, to whose description reference is hereby expressly made.

FIG. 5 shows a perspective view of the adapter device 300. The adapter device comprises an adapter unit 302 and a fastening unit 304. Furthermore, the adapter unit 302 has a front adapter sub-unit 336 and a rear adapter sub-unit 338 arranged further back in the longitudinal direction L. All the features described above for the adapter unit 102 and the adapter unit 202 can be applied to the front adapter via sub-unit 336.

The front adapter sub-unit 336 and the rear adapter sub-unit 338 are movably connected to each other. This can take place via a joint 340. The joint 340 can have a swivel angle of at least 180°, so that in a closed state the front 336 and the rear adapter sub-unit 338 rest against each other.

The adapter unit 302 has an asymmetrical shape. In particular, the front adapter sub-unit 336 is asymmetrically shaped. This allows the front adapter sub-unit 336 to be adapted to the shape of the sole of an everyday shoe. Furthermore, the front adapter unit 336 is essentially plate-shaped.

The rear adapter sub-unit 338 can have an essentially trapezoidal contour. The extension of the rear adapter sub-unit 338 in the transverse direction Q can be less than the extension of the front adapter sub-unit 336 in the transverse direction Q. The front adapter sub-unit 336 has a length 302c of approximately 83 mm in the longitudinal direction L.

A mounting section 306 is located on the front adapter sub-unit 336 (see FIG. 7). An insert unit 342, which accommodates at least one insert element 344, is arranged in the mounting section 306. At least one click element can be mounted on the insert element 344 in an operationally fixed manner. The insert unit 342 can be formed in one piece with the mounting section 306 or as a separate component.

As shown in FIG. 6, the front adapter subassembly 336 may include an upper adapter subassembly 336a and a lower adapter subassembly 336b that abut each other.

The lower adapter sub-unit 336b can comprise at least one side wall 320, which protrudes downwards in the height direction from a base plate 322 of the adapter unit 302. More precisely, the side wall 320 protrudes on the side of the base plate 322 that is intended for mounting a click element.

Furthermore, fastening eyelets 334 are provided, which protrude from the adapter unit 302 at edge sections 302b. Here, at least two fastening lugs 334 lie opposite each other in the transverse direction Q.

Fastening elements 312, for example straps, can be passed through the fastening eyelets. For detachable fastening of the adapter device 300 to an everyday shoe, the fastening elements 312 can be connected to one another on an upper side of the everyday shoe in the height direction. In this case, the adapter unit 302 is attached to the opposite side, namely the lower side, of the everyday shoe.

At a rear end 336c, or at rear corner portions 336d of the front adapter subunit 336, rear fastening lugs 334a are provided, which serve to fasten end portions 312c (not shown). The rear fastening eyelets 334a lie at an angle against rear corner sections 336d.

It is also conceivable to attach at least one further fastening element to the rear adapter sub-unit 338 in a similar manner. By means of this further fastening element, the adapter device 300 can be detachably fastened to the heel of an everyday shoe, for example.

At least two fastening elements 312 can be arranged to overlap. Eyelets 346 can be used to stabilize the overlap.

The adapter unit 302 also comprises at least one bore 332, which is intended to receive a pedal pin.

Furthermore, the adapter unit 302 comprises a plurality of holes 330. These holes 330 are formed as elongated holes which extend in the longitudinal direction. The elongated holes are at least 24 mm long. They can have a length in the longitudinal direction of approximately 28 mm. In the transverse direction, the elongated holes can have a width of approximately 7 mm. An internal thread (not shown) can be slidably arranged within at least one of the holes 330.

FIG. 8 shows a front adapter sub-unit 436 and FIG. 9 a rear adapter sub-unit 438. The front adapter sub-unit 436 essentially corresponds to the front adapter sub-unit 336 and the rear adapter sub-unit 438 essentially corresponds to the rear adapter sub-unit 338 according to FIGS. 5 to 7. Therefore, in FIGS. 8 and 9, analogous parts are provided with the same reference signs as in FIGS. 5 to 7, but increased by 100. Furthermore, the description of analog parts is dispensed with and express reference is hereby made to the description of FIGS. 5 to 7. However, it is also possible to dispense with a rear adapter sub-unit, so that the front adapter sub-unit 436 is equal to an adapter unit 402.

The front adapter sub-unit 436 has a topology-optimized shape. A recess 448 is provided at a rear end 436c. This can accommodate a connecting element, for example a joint 440, for connecting the front adapter sub-unit 436 to a rear adapter sub-unit.

The rear adapter sub-unit 438 has a trapezoidal shape that becomes wider towards the rear, i.e. in the longitudinal direction L in the direction of the heel-side end. An asymmetry in the transverse direction Q enables adaptation to the shape of the sole of an everyday shoe, for example a right everyday shoe.

A joint 440 is attached to an underside of the rear adapter sub-unit 438. By means of the joint 440, the rear adapter sub-unit 438 can be movably connected to a front adapter sub-unit, such as the adapter unit 102 or one of the front adapter sub-units 336 or 436.

An upper adapter sub-unit 516 (see FIG. 10) may be attached to an adapter unit 502, for example a front adapter sub-unit. The upper adapter unit 516 comprises at least one mounting section 506, which has a plurality of holes 530. The holes 530, in this case two, are designed as elongated holes extending in the longitudinal direction L. A click element can be mounted on the upper adapter sub-unit 516 via the holes 530. For this purpose, a displaceable internal thread can be arranged in a hole 530, which can accommodate a mounting element, for example a screw.

In particular, if an adapter unit 502 comprises a lower adapter unit with at least one side wall, a click element can be mounted directly on the upper adapter unit 516. In this case, the upper adapter unit 516 is also a base plate 522.

Furthermore, the upper adapter unit 516 has a plurality of holes 536. By inserting connecting elements into the holes 536 and bringing them into engagement with corresponding ding holes provided on a lower adapter sub-unit, the upper adapter unit 516 can be connected to a lower adapter sub-unit. If, for example, pedal pins were used as connecting elements, these would have two effects, namely 28 connecting the upper and lower adapter subunit and reducing the slipping of the adapter unit on a pedal.

FIG. 11 shows a cross-section of the adapter unit 602 of an adapter device 600. An upper adapter sub-sub-unit 636a and a lower adapter sub sub-unit 636b are adjacent to each other. A fastening element 612 is arranged between the upper adapter sub unit 636a and the lower adapter sub-unit 636b. The fastening element 612 is in direct contact with both the upper adapter subunit 636a and the lower adapter subunit 636b. In other words, the fastening element 612 is sandwiched between the upper adapter sub-unit 636a and the lower adapter sub-unit 636b.

The fastening element 612 can be integrally formed between the upper adapter sub-unit 636a and the lower adapter sub-unit 636b. Fastening element sections 612c protrude from the adapter unit 602 from fastening eyelets 634 on edge sections 602b of the upper adapter subunit 636a that are opposite each other in the transverse direction.

The fastening element sections 612c, which protrude from the adapter unit 602, can be placed around an everyday shoe and connected to one another, for example by means of a quick-release fastener. This results in a detachable fastening of the adapter device 600 to an everyday shoe.

It is self-evident that the present invention is not limited to the described embodiments. Furthermore, it is obvious that the features described can be combined with one another in any desired manner by adding or omitting features.

1. Adapter device comprising:
an adapter unit which has at least one mounting section which is designed and intended to mount at least one click element, not belonging to the adapter device, of a clipless pedal system, likewise not belonging to the adapter device, on the adapter unit in an operationally fixed manner, and
la fastening unit which is designed and intended for detachably fastening the adapter unit to an everyday shoe which is also not part of the adapter device,
wherein the adapter unit comprises an upper adapter sub-unit and a lower adapter sub-unit which, at least when the adapter device is in use, are in direct or indirect contact with one another, and
wherein at least one fastening element is sandwiched between the upper adapter sub-unit and the lower adapter sub-unit.

2. Adapter device according to claim 1, wherein the fastening unit comprises at least one fastening element.

3. Adapter device according to claim 2, wherein the adapter unit has at least one fastening eyelet for connecting the at least one fastening element to the adapter unit.

4-5. (canceled)

6. Adapter device according to claim 2, wherein at least two fastening element sections, which are arranged on mutually different edge sections of the adapter unit, lie opposite one another in the transverse direction.

7. Adapter device according to claim 2, wherein two fastening element sections are fastened to a rear end of the adapter unit.

8. (canceled)

9. Adapter device according to claim 1, wherein the adapter unit is plate-shaped.

10. Adapter device according to claim 1, wherein the adapter unit comprises at least one side wall which projects from a base plate of the adapter unit on that side which is intended for mounting the click element.

11. Adapter device according to claim 7, wherein the at least one side wall is arranged in such a way that it has a predetermined minimum distance from the click element in the mounted state of the latter.

12. Adapter device according to claim 7, wherein the at least one side wall has a height of at least 6 mm.

13. Adapter device according to claim 7, wherein a surface of the at least one side wall facing away from the base plate is provided with a profile and/or is manufactured using a non-slip material.

14. Adapter device according to claim 1, wherein the adapter unit is manufactured using a rigid material and/or using a plastic.

15. Adapter device according to claim 1, wherein the adapter unit is provided with at least one bore which is designed and intended to receive a pedal pin.

16. Adapter device according to claim 1, wherein the adapter unit is manufactured using a non-slip material and/or shock-absorbing material.

17. Adapter device according to claim 1, wherein the adapter unit has a predetermined minimum length in the longitudinal direction.

18-23. (canceled)

24. Adapter device according to claim 2, wherein the at least one fastening element (112, 312) comprises at least one strap and/or at least one belt and/or at least one cord.

25. Adapter device according to claim 15, wherein the at least one belt and/or the at least one strap and/or the at least one cord is manufactured using a material with a high tensile stiffness and/or using a tensile elastic material.

26. Adapter device according to claim 2, wherein the at least one fastening element comprises a quick-release fastener.

27. Adapter device according to claim 1, wherein the mounting portion has a plurality of holes.

28-29. (canceled)

30. Adapter device according to claim 18, wherein at least one hole has an internal thread.

31. (canceled)

32. Adapter device according to claim 18, wherein the adapter unit is provided with at least one scale next to at least one of the plurality of holes.

33. Combination of an adapter device according to claim 1 with a click element, which is operatively fixedly mounted on the adapter device.

34. Combination according to claim 21, wherein it further comprises an everyday shoe to which the adapter device can be detachably attached.
